(19) United States
(12) Patent Application Publication
(10) Pub. No.: US 2025/0130645 A1
(43) Pub. Date: Apr. 24, 2025

(54) OPERATION DETECTION APPARATUS, INFORMATION PROCESSING SYSTEM, AND OPERATION DETECTION METHOD

(71) Applicant: SONY SEMICONDUCTOR SOLUTIONS CORPORATION, KANAGAWA (JP)

(72) Inventor: SHOGO TAKANASHI, KANAGAWA (JP)

(21) Appl. No.: 18/684,863

(22) PCT Filed: Jun. 3, 2022
(86) PCT No.: PCT/JP2022/022648

§ 371 Date: Feb. 20, 2024

(30) Foreign Application Priority Data
Sep. 6, 2021 (JP) 2021-144941

(51) Int. Cl. G06F 3/01

(52) U.S. Cl. CPC G06F 3/017

(57) ABSTRACT

[Problem] Provided is a technology advantageous for flexibly associating an operation instruction with an operation behavior indicated by an occupant of a conveyance. [Solution] An operation detection apparatus includes: an input standard region recognition unit configured to acquire standard position information representing a three-dimensional position of an input standard region in a conveyance; an operation behavior recognition unit configured to acquire operation behavior information representing a three-dimensional operation behavior indicated by an operator on board on the conveyance, on the basis of a detection result of a sensor mounted on the conveyance; and an operation instruction recognition unit configured to acquire operation instruction information representing an operation instruction for the conveyance on the basis of a relationship between the input standard region and the operation behavior, in which the relationship is derived from the standard position information and the operation behavior information.

### TECHNICAL FIELD

The present disclosure relates to an operation detection apparatus, an information processing system, and an operation detection method.

### BACKGROUND ART

There is known an apparatus that utilizes an in-vehicle apparatus (for example, a navigation system or audio-visual equipment (AV equipment)) in order to operate a car.

For example, in a handle operation detection device disclosed in Patent Document 1, a sensor (electrode) embedded in a handle is used as an input means.

Furthermore, in a display device disclosed in Patent Document 2, a detection unit that detects a movement of a hand of a user with respect to a steering wheel by using a contact sensor or a non-contact sensor is used as an input means.

### CITATION LIST

### Patent Document

Patent Document 1: Japanese Patent Application Laid-Open No. 2020-72437
Patent Document 2: Japanese Patent Application Laid-Open No. 2020-50000

### SUMMARY OF THE INVENTION

### Problems to be Solved by the Invention

In a case where an operation instruction is given using a sensor attached to an in-vehicle apparatus as in the device disclosed in Patent Document 1, it is necessary to attach the sensor to the in-vehicle apparatus at the time of manufacturing the in-vehicle apparatus, which increases manufacturing cost and time and effort. Furthermore, in order to expand a detection range of an operation movement indicated by an occupant or improve detection accuracy, it is necessary to increase the number of sensors or use high-performance sensors, which increases device cost. Furthermore, a place where the sensor can be installed is limited, and arrangement and design of other in-vehicle apparatuses are also restricted according to an installation mode of the sensor. Furthermore, since a content of the operation instruction that can be allocated to the sensor is limited, it is difficult to perform various operation instructions.

The detection unit using the non-contact sensor disclosed in Patent Document 2 can detect a two-dimensional simple motion of the hand of the user, but cannot detect a three-dimensional fine motion of the hand. Therefore, in the device of Patent Document 2, it is possible to associate a simple hand motion with an operation content, but it is not possible to associate a three-dimensional complicated hand motion or various hand motions with an operation content.

As described above, in the devices disclosed in Patent Document 1 and Patent Document 2, a content of an operation instruction that can be associated with an operation behavior of an occupant is limited, and thus it must be said that both are insufficient from the viewpoint of practicality.

The present disclosure provides a technology advantageous for flexibly associating an operation instruction with an operation behavior indicated by an occupant of a conveyance.

### Solutions to Problems

One aspect of the present disclosure relates to an operation detection apparatus including: an input standard region recognition unit configured to acquire standard position information representing a three-dimensional position of an input standard region in a conveyance; an operation behavior recognition unit configured to acquire operation behavior information representing a three-dimensional operation behavior indicated by an operator on board on the conveyance, on the basis of a detection result of a sensor mounted on the conveyance; and an operation instruction recognition unit configured to acquire operation instruction information representing an operation instruction for the conveyance on the basis of a relationship between the input standard region and the operation behavior, in which the relationship is derived from the standard position information and the operation behavior information.

The input standard region may be a region defined in advance.

The input standard region may be a designated region designated by the operator.

The input standard region recognition unit may acquire designated region information representing a region designation behavior indicated by the operator on the basis of a detection result of a sensor mounted on the conveyance, and the input standard region recognition unit may recognize the designated region on the basis of the designated region information.

The input standard region may be a region defined on the basis of a structure mounted on a conveyance.

The input standard region may be a spatial region.

The operation instruction recognition unit may acquire the operation instruction information on the basis of a distance between the input standard region and the operator, in which the distance is derived from the standard position information and the operation behavior information.

The operation instruction recognition unit may acquire the operation instruction information on the basis of a movement pattern of the operation behavior with respect to the input standard region, in which the movement pattern is derived from the standard position information and the operation behavior information.

The operation instruction recognition unit may refer to reference instruction information associating the movement pattern of the operation behavior with respect to the input standard region with the corresponding operation instruction information, to acquire the operation instruction information associated with the movement pattern of the operation behavior with respect to the input standard region, in which the movement pattern is derived from the standard position information and the operation behavior information.

The operation detection apparatus may include an operator identification unit configured to acquire identification information representing the operator, the input standard region recognition unit may read input standard region information associated with the identification information from an information storage unit, and the input standard region recognition unit may acquire the standard position information on the basis of the input standard region information.

The operation detection apparatus may include an operator identification unit configured to acquire identification information representing the operator, and the operation instruction recognition unit may refer to reference operation instruction information that is determined for each piece of the identification information and makes a relationship between the input standard region and the operation behavior to correspond to the operation instruction information, and the operation instruction recognition unit may acquire the operation instruction information associated with the identification information.

The sensor may be a ToF sensor.

The conveyance may be a vehicle.

Another aspect of the present disclosure relates to an information processing system including: a sensor mounted on a conveyance; and an operation detection apparatus configured to acquire operation instruction information representing an operation instruction for the conveyance, in which the operation detection apparatus includes: an input standard region recognition unit configured to acquire standard position information representing a three-dimensional position of an input standard region in a conveyance; an operation behavior recognition unit configured to acquire operation behavior information representing a three-dimensional operation behavior indicated by an operator on board on the conveyance, on the basis of a detection result of the sensor; and an operation instruction recognition unit configured to acquire the operation instruction information on the basis of a relative relationship between the input standard region and the operation behavior, in which the relative relationship is derived from the standard position information and the operation behavior information.

The information processing system may include a device control unit configured to control a device included in the conveyance on the basis of the operation instruction information.

Another aspect of the present disclosure relates to an operation detection method including: a step of acquiring standard position information representing a three-dimensional position of an input standard region in a conveyance; a step of acquiring operation behavior information representing a three-dimensional operation behavior indicated by an operator on board on the conveyance, on the basis of a detection result of a sensor mounted on the conveyance; and a step of acquiring operation instruction information representing an operation instruction for the conveyance on the basis of a relationship between the input standard region and the operation behavior, in which the relationship is derived from the standard position information and the operation behavior information.

The operation detection method may include a step of controlling a device included in the conveyance on the basis of the operation instruction information.

### BRIEF DESCRIPTION OF DRAWINGS

FIG. 1 is a view illustrating an example of a schematic configuration of a vehicle.

FIG. 2 is a block diagram illustrating a functional configuration example of a three-dimensional position information processing apparatus according to a first embodiment.

FIG. 3 is a view illustrating an example of a method of expressing standard position information representing a three-dimensional position of a steering wheel which is an input standard region.

FIG. 4 is a view for explaining an example of a method of expressing operation behavior information representing a three-dimensional operation behavior of an operation hand.

FIG. 5A is a view illustrating an example of a relationship between an input standard region and an operation behavior.

FIG. 5B is a view illustrating an example of a relationship between an input standard region and an operation behavior.

FIG. 6 is a view illustrating an example of the steering wheel which is an input standard region.

FIG. 7 illustrates an example of an operation instruction associated with an operation region (a first hole region to a third wheel region) of the steering wheel.

FIG. 8A is a view illustrating an example of a gear shift to be used as an input standard region.

FIG. 8B is a view illustrating an example of an operation behavior of the operation hand with respect to a first shift region of the gear shift.

FIG. 8C is a view illustrating an example of an operation behavior of the operation hand with respect to a second shift region of the gear shift.

FIG. 8D is a view illustrating an example of an operation behavior of the operation hand with respect to a third shift region of the gear shift.

FIG. 9 illustrates an example of an operation instruction associated with an operation region (the first shift region to the third shift region) of the gear shift.

FIG. 10 is a block diagram illustrating a functional configuration example of a three-dimensional position information processing apparatus according to a second embodiment.

FIG. 11 illustrates an example of a method of designating a spatial region to be used as an input standard region by an operation hand.

FIG. 12 illustrates an example of the method of designating the spatial region to be used as an input standard region by the operation hand.

FIG. 13 illustrates another example of the method of designating the spatial region to be used as an input standard region by the operation hand.

FIG. 14 is a block diagram illustrating a functional configuration example of a three-dimensional position information processing apparatus according to a third embodiment.

### MODE FOR CARRYING OUT THE INVENTION

Hereinafter, typical embodiments of the present disclosure will be described with reference to the drawings.

In each embodiment described below, a case will be described in which the technology of the present disclosure (an operation detection apparatus, an information processing system, and an operation detection method) is applied to a vehicle.

However, a conveyance to which the technology of the present disclosure can be applied is not limited to a vehicle. For example, the technology of the present disclosure is also applicable to flying bodies (such as airplanes), ships, and other mobile bodies. Furthermore, the technology of the present disclosure is also applicable to non-mobile bodies.

### First Embodiment

In the present embodiment, when an occupant in a vehicle interior operates an information terminal mounted on a vehicle (passenger car), an in-vehicle apparatus such as a steering wheel or a gear shift is used as an input means. That is, by using a sensor capable of detecting a three-dimensional motion of the occupant of the vehicle, and linking a relationship between the in-vehicle apparatus and the three-dimensional motion of the occupant detected by the sensor with a specific operation instruction for the information terminal, the occupant can operate the information terminal.

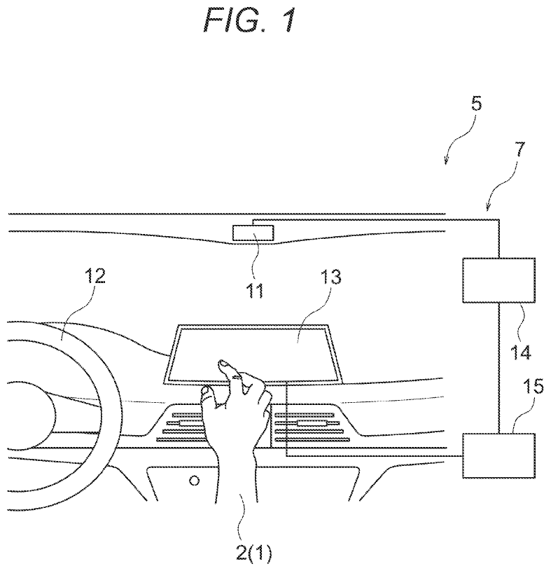

FIG. 1 is a view illustrating an example of a schematic configuration of a vehicle 5.

FIG. 1 illustrates a case where, as an operator 1, an occupant (that is, a driver) sitting on a driver's seat operates an information terminal (that is, an application audiovisual apparatus 13). Note that the operator 1 is not limited to the driver, and other persons (for example, an occupant in a passenger seat or an occupant in a rear seat) on board on the vehicle 5 can also be the operator 1.

The vehicle 5 includes, as an information processing system 7, a three-dimensional position measurement apparatus 11, a steering wheel 12, the application audiovisual apparatus 13, a three-dimensional position information processing apparatus 14, and an application operation processing apparatus 15.

The three-dimensional position measurement apparatus 11 is a sensor mounted on the vehicle 5, and includes a sensor capable of detecting a three-dimensional operation behavior indicated by the operator 1 in a non-contact manner.

The sensor of the three-dimensional position measurement apparatus 11 of the present embodiment acquires not only three-dimensional position information of the operator 1 but also three-dimensional position information of other entities located within a detection range of the sensor. The three-dimensional position information acquired by the sensor is sent as measured position information from the three-dimensional position measurement apparatus 11 to the three-dimensional position information processing apparatus 14.

A specific type, installation position, and detection method of the sensor of the three-dimensional position measurement apparatus 11 are not limited.

For example, the three-dimensional position measurement apparatus 11 may include a light emitting unit that emits pulsed light (for example, laser light) and a sensor that receives scattered light of the light. Typically, a time of flight (ToF) sensor (for example, light detection and ranging (LiDAR)) whose detection site is directed to the vehicle interior can be used as a sensor of the three-dimensional position measurement apparatus 11.

The sensor of the three-dimensional position measurement apparatus 11 is installed such that a normal movement range of a hand of the operator 1 (that is, an operation hand 2) is included in a detection range of the sensor, and an operation movement of the operation hand 2 is made in a measurement range of the three-dimensional position measurement apparatus 11.

In the example illustrated in FIG. 1, the sensor of the three-dimensional position measurement apparatus 11 is installed on a ceiling of the vehicle, a detection unit of the sensor faces directly below, and a region below the sensor is the detection range of the sensor (that is, the measurement range of the three-dimensional position measurement apparatus 11).

The three-dimensional position information processing apparatus 14 is an operation detection apparatus that acquires operation instruction information representing an operation instruction for the vehicle 5.

The three-dimensional position information processing apparatus 14 of the present embodiment acquires the operation instruction information by comparing the three-dimensional position information of the operation hand 2 measured by the three-dimensional position measurement apparatus 11 with the three-dimensional position information of the in-vehicle apparatus (the steering wheel 12 in the example of FIG. 1) used as the input means.

For example, the three-dimensional position information processing apparatus 14 detects whether or not the operation hand 2 has touched the steering wheel 12, which position of the steering wheel 12 the operation hand 2 has touched, and/or which direction the operation hand 2 has moved with respect to the steering wheel 12.

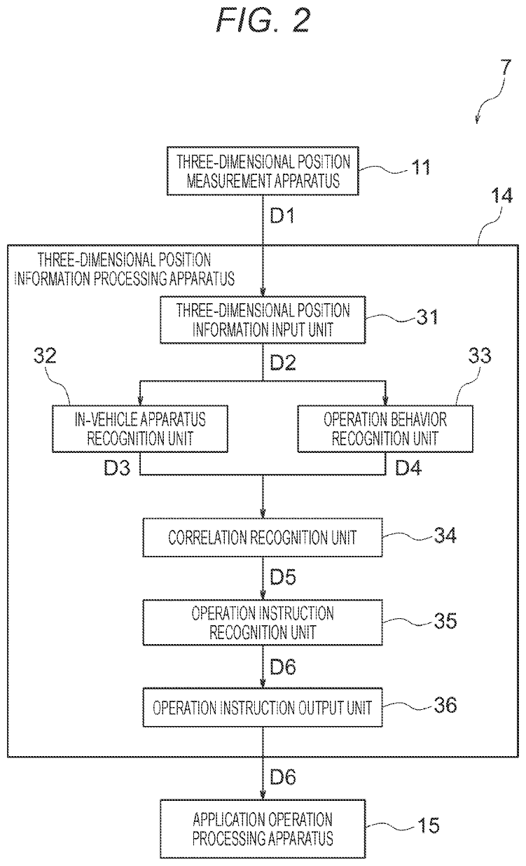

A specific configuration example of the three-dimensional position information processing apparatus 14 will be described later (see FIG. 2).

The application operation processing apparatus 15 functions as a device control unit, and controls a device (the application audiovisual apparatus 13 in this example) included in the vehicle 5 on the basis of the operation instruction information acquired by the three-dimensional position information processing apparatus 14.

As described above, in the present example, a relative movement relationship between the operation hand 2 and the steering wheel 12 is linked with an operation instruction for an application of the application audiovisual apparatus 13. For example, in a case where the application involves video and audio outputs, the application operation processing apparatus 15 may change the video and audio outputs from the application audiovisual apparatus 13 in accordance with an operation behavior of the operation hand 2 with respect to the steering wheel 12.

Although the three-dimensional position information processing apparatus 14 and the application operation processing apparatus 15 are provided separately in the example illustrated in FIG. 1, the three-dimensional position information processing apparatus 14 and the application operation processing apparatus 15 may be integrally provided. That is, the three-dimensional position information processing apparatus 14 and the application operation processing apparatus 15 may be realized by a common apparatus having functions of both apparatuses.

Furthermore, each of the three-dimensional position information processing apparatus 14 and the application operation processing apparatus 15 may be realized by a single apparatus, or may be realized by cooperation of two or more apparatuses.

As described above, in the present example, the operation instruction information is acquired by processing a measurement result of the three-dimensional position measurement apparatus 11 by using the three-dimensional position information processing apparatus 14, and the application operation processing apparatus 15 controls the application audiovisual apparatus 13 on the basis of the operation instruction information.

The application audiovisual apparatus 13 provides various types of information to the occupant of the vehicle by using video and audio, and typically provides the occupant with various types of information related to traveling of the vehicle 5, route guidance information, peripheral information, music, and any other information.

The application audiovisual apparatus 13 illustrated in FIG. 1 includes a display installed on a dashboard of the vehicle 5, but an installation location of the display is not limited. Furthermore, the application audiovisual apparatus 13 may not include the display, and may be configured as a head-up display apparatus, for example.

The application audiovisual apparatus 13 may include a button, a dial, a touch panel, and other instruction input units (not illustrated) that receive an input from the occupant. In this case, the application audiovisual apparatus 13 is operation-controlled by the application operation processing apparatus 15 as described above, and is operation-controlled on the basis of an instruction that is from the occupant and is received by the instruction input unit.

As an apparatus for operation of the application audiovisual apparatus 13, any other apparatus may be provided in addition to the three-dimensional position measurement apparatus 11 and the three-dimensional position information processing apparatus 14 described above. That is, an operation apparatus for control of the application audiovisual apparatus 13 may be additionally provided separately from the three-dimensional position measurement apparatus 11 and the three-dimensional position information processing apparatus 14.

Such other operation apparatus can be installed in any form, and may be provided as a physical switch (for example, a button) of a contact operation type attached to an existing in-vehicle apparatus (for example, the steering wheel 12). The operation instruction information input by the operator 1 via other operation apparatus may be sent to the application operation processing apparatus 15 or may be sent to another apparatuses capable of controlling the application audiovisual apparatus 13. The operator 1 can selectively or simultaneously operate the application audiovisual apparatus 13 via the three-dimensional position measurement apparatus 11, and operate the application audiovisual apparatus 13 via other operation apparatus.

Next, a specific configuration example of the three-dimensional position information processing apparatus 14 will be described.

FIG. 2 is a block diagram illustrating a functional configuration example of the three-dimensional position information processing apparatus 14 according to a first embodiment.

Each block illustrated in FIG. 2 is realized by any hardware and/or software. Two or more blocks illustrated in FIG. 2 may be realized by common hardware and/or software.

The three-dimensional position information processing apparatus 14 illustrated in FIG. 2 includes a three-dimensional position information input unit 31, an in-vehicle apparatus recognition unit 32, an operation behavior recognition unit 33, a correlation recognition unit 34, an operation instruction recognition unit 35, and an operation instruction output unit 36.

The three-dimensional position information input unit 31 processes measured position information D1 acquired by the three-dimensional position measurement apparatus 11, to acquire three-dimensional position data (that is, three-dimensional position information D2) of an entity (including the in-vehicle apparatus and the operation hand 2) within a measurement range of the three-dimensional position measurement apparatus 11.

A specific processing content performed by the three-dimensional position information input unit 31 is not limited, and the three-dimensional position information input unit 31 acquires the three-dimensional position information D2 from the measured position information D1 by using any processing method. The three-dimensional position information input unit 31 may convert the measured position information D1 sent from the three-dimensional position measurement apparatus 11 into three-dimensional data (for example, XYZ coordinate data), to acquire depth map data of the measurement range of the three-dimensional position measurement apparatus 11.

For example, the three-dimensional position information input unit 31 can derive point cloud data of a three-dimensional position of the operation hand 2 from the measured position information D1. The point cloud data of the three-dimensional position of the operation hand 2 can be expressed by a set of three-dimensional coordinate points (x, y, z) indicating a position of the operation hand 2 obtained by freely setting an origin. In the point cloud data of the three-dimensional position of the operation hand 2, the number of points indicating the position of the operation hand 2 depends on a distance measuring resolution of the three-dimensional position measurement apparatus 11.

Note that the above-described processing performed by the three-dimensional position information input unit 31 can be performed on the basis of a known technique. A specific and detailed description of such processing is omitted in the present description, but can be appropriately understood by those skilled in the art.

The in-vehicle apparatus recognition unit 32 works as an input standard region recognition unit, and acquires standard position information D3 representing a three-dimensional position of an input standard region in the vehicle 5 on the basis of the three-dimensional position information D2 acquired by the three-dimensional position information input unit 31.

The input standard region of the present embodiment is a region defined on the basis of a structure mounted on the vehicle 5, and is defined by the steering wheel 12 in the example illustrated in FIG. 1.

The input standard region may be a region defined in advance or a designated region designated by the operator 1.

In a case where the input standard region is a region defined in advance, the in-vehicle apparatus recognition unit 32 can automatically recognize the input standard region (that is, the steering wheel 12) by analyzing the three-dimensional position information D2 (for example, the point cloud data).

In this case, it is not necessary to manually prepare the standard position information D3 of the input standard region in advance. Note that the in-vehicle apparatus recognition unit 32 can increase estimation accuracy of the three-dimensional position of the input standard region by using any machine learning inference model in analysis of the three-dimensional position information D2. The machine learning inference model that can be used by the in-vehicle apparatus recognition unit 32 is not limited, and a known inference model can be used. Therefore, a specific and detailed description of such a machine learning inference model is omitted in the present description.

Whereas, in a case where the input standard region is manually designated by the operator 1, the operator 1 designates the input standard region by using any method.

For example, the in-vehicle apparatus recognition unit 32 may recognize the input standard region by processing information about the designated movement of the operation hand 2 acquired via the three-dimensional position measurement apparatus 11. Alternatively, the in-vehicle apparatus recognition unit 32 may recognize the input standard region on the basis of information input by the operator 1 via any input means (for example, an instruction input unit included in the application audiovisual apparatus 13).

In a case where the input standard region is manually designated in this way, data indicating a three-dimensional position of the input standard region may be data prepared manually by the operator 1 or the like, or may be data derived from a measurement result of the three-dimensional position measurement apparatus 11.

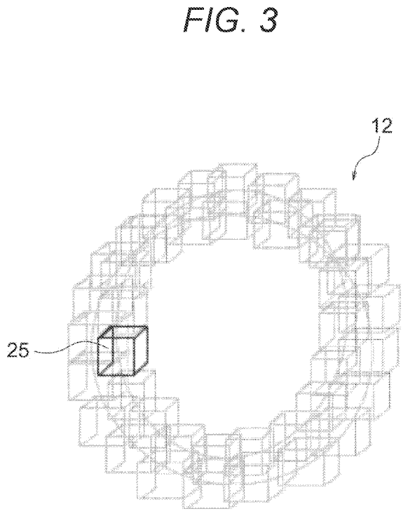

FIG. 3 is a view illustrating an example of a method of expressing the standard position information D3 representing a three-dimensional position of the steering wheel 12 which is the input standard region.

In the example illustrated in FIG. 3, the steering wheel 12 is represented by combining a plurality of modeling elements 25, and the standard position information D3 of the steering wheel 12 is represented by a set of position data of the plurality of modeling elements 25.

The plurality of modeling elements 25 is arranged to contain a main portion of the steering wheel 12, and a set of these modeling elements 25 is regarded as the input standard region. For example, each modeling element 25 is defined by a rectangular parallelepiped (typically a cube) having any size, and a plurality of modeling elements 25 having the same shape and the same size is used. In the example illustrated in FIG. 3, the standard position information D3 of the steering wheel 12 can be represented by data of a size (a vertical size, a horizontal size, and a height size) of each modeling element 25 and data of center coordinates of each modeling element 25.

In a case where a position of the input standard region (the steering wheel 12 in this example) basically does not move, the in-vehicle apparatus recognition unit 32 may read the standard position information D3 from a storage unit (not illustrated) that stores the standard position information D3 of the input standard region, to use the standard position information D3.

The operation behavior recognition unit 33 (see FIG. 2) works as an operation behavior recognition unit, and acquires operation behavior information D4 indicating a three-dimensional operation behavior indicated by the operator 1 on board on the vehicle 5, on the basis of a measurement result of the three-dimensional position measurement apparatus 11. The operation behavior recognition unit 33 illustrated in FIG. 2 analyzes the three-dimensional position information D2 acquired by the three-dimensional position information input unit 31, to acquire the operation behavior information D4 indicating a three-dimensional operation behavior of the operation hand 2.

A method of analyzing the three-dimensional position information D2 performed by the operation behavior recognition unit 33 is not limited. As an example, the operation behavior recognition unit 33 can improve estimation accuracy of the three-dimensional operation behavior of the operation hand 2, by using any machine learning inference model in analysis of the three-dimensional position information D2. The machine learning inference model that can be used by the operation behavior recognition unit 33 is not limited, and a known inference model can be used. Therefore, a specific and detailed description of such a machine learning inference model is omitted in the present description.

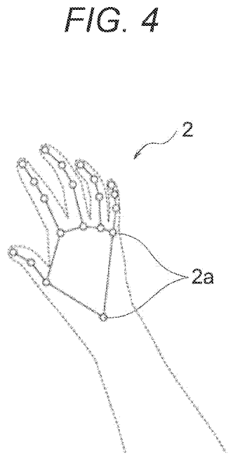

FIG. 4 is a view illustrating an example of a method of expressing the operation behavior information D4 representing a three-dimensional operation behavior of the operation hand 2.

In the example illustrated in FIG. 4, the operation behavior information D4 is represented by three-dimensional position information (position coordinates) of a plurality of joint points 2a of the operation hand 2. Therefore, the operation behavior information D4 includes not only position information of the operation hand 2 but also shape information of the operation hand 2. Note that, as the number of joint points 2a used to express the operation behavior information D4 is larger, a finer behavior of the operation hand 2 can be expressed by the operation behavior information D4, and thus a degree of freedom of a recognizable operation movement increases.

The correlation recognition unit 34 illustrated in FIG. 2 derives correlation information D5 indicating a relationship between the input standard region and the operation behavior, on the basis of the standard position information D3 and the operation behavior information D4. A specific relationship between the input standard region and the operation behavior that can be represented by the correlation information D5 is not limited.

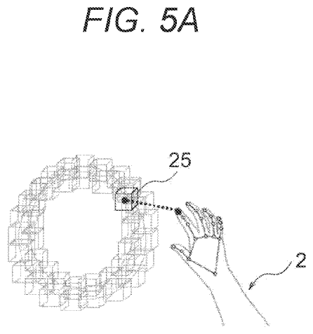

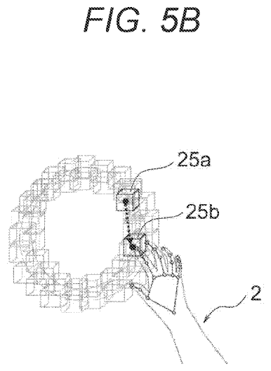

FIGS. 5A and 5B are views illustrating an example of a relationship between an input standard region and an operation behavior.

For example, as illustrated in FIG. 5A, a three-dimensional distance between the steering wheel 12 (more specifically, the modeling element 25), which is the input standard region, and the operation hand 2 may be represented by the correlation information D5.

Furthermore, a three-dimensional movement pattern (that is, a gesture) of the operation behavior of the operation hand 2 with respect to the input standard region (the steering wheel 12) may be represented by the correlation information D5. In the example illustrated in FIG. 5B, when the position of the operation hand 2 is changed from a first modeling element 25a to a second modeling element 25b, a movement pattern of the operation hand 2 slidingly moving along the input standard region (steering wheel 12) is recognized.

Note that, when deriving the correlation information D5 from the standard position information D3 and the operation behavior information D4, the correlation recognition unit 34 can improve estimation accuracy of the relationship between the input standard region and the operation behavior by using any machine learning inference model. The machine learning inference model that can be used by the correlation recognition unit 34 is not limited, and a known inference model can be used. Therefore, a specific and detailed description of such a machine learning inference model is omitted in the present description.

The operation instruction recognition unit 35 acquires operation instruction information D6 indicating an operation instruction for the vehicle 5, on the basis of the relationship between the input standard region and the operation behavior indicated by the correlation information D5.

For example, the operation instruction recognition unit 35 may refer to preset reference instruction information, and acquire the operation instruction information D6 on the basis of the relationship between the input standard region and the operation behavior indicated by the correlation information D5. The reference instruction information used here associates the relationship between the input standard region and the operation behavior with the corresponding operation instruction information.

For example, the reference instruction information may associate a three-dimensional distance between the input standard region and the operation hand 2 with the corresponding operation instruction information. In this case, the operation instruction recognition unit 35 refers to the reference instruction information, to acquire the operation instruction information D6 associated with the “three-dimensional distance between the input standard region and the operation hand 2 of the operator 1” derived from the standard position information D3 and the operation behavior information D4.

Furthermore, the reference instruction information may associate a movement pattern (gesture) of the operation behavior with respect to the input standard region with the corresponding operation instruction information. In this case, the operation instruction recognition unit 35 refers to the reference instruction information, to acquire the operation instruction information D6 associated with “the three-dimensional movement pattern of the operation behavior of the operation hand 2 with respect to the input standard region” derived from the standard position information D3 and the operation behavior information D4.

The operation instruction output unit 36 transmits the operation instruction information D6 acquired by the operation instruction recognition unit 35 to the application operation processing apparatus 15.

As described above, the operation detection method of the present embodiment includes the following steps.

That is, the in-vehicle apparatus recognition unit 32 acquires the standard position information D3 indicating a three-dimensional position of the input standard region (steering wheel 12) in the vehicle 5. Furthermore, the operation behavior recognition unit 33 acquires the operation behavior information D4 indicating a three-dimensional operation behavior indicated by the operator 1 on board on the vehicle 5, on the basis of a detection result of the sensor of the three-dimensional position measurement apparatus 11 mounted on the vehicle 5. Then, the operation instruction recognition unit 35 acquires the operation instruction information D6 indicating an operation instruction for the vehicle 5, on the basis of a relationship (the correlation information D5) between the input standard region and the operation behavior derived from the standard position information D3 and the operation behavior information D4. Then, a device (the application audiovisual apparatus 13 in the present embodiment) included in the vehicle 5 is controlled by the application operation processing apparatus 15 on the basis of the operation instruction information D6.

Next, a practical example of control of the application audiovisual apparatus 13 will be described.

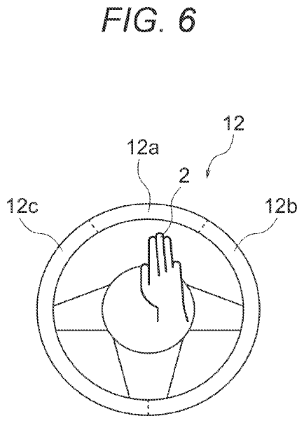

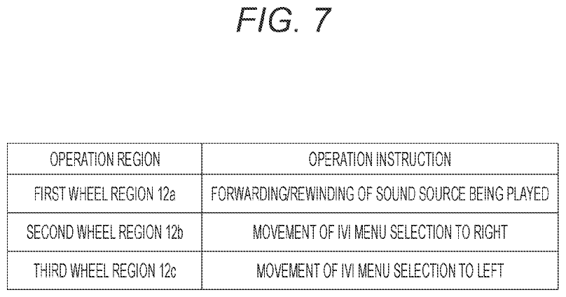

FIG. 6 is a view illustrating an example of the steering wheel 12 which is the input standard region. FIG. 7 illustrates an example of an operation instruction associated with an operation region (a first hole region 12a to a third wheel region 12c) of the steering wheel 12.

In the example illustrated in FIGS. 6 and 7, the steering wheel 12 (input standard region) includes the first hole region 12a, and the second wheel region 12b and the third wheel region 12c that are adjacent to the first hole region 12a.

For example, the operator 1 can make an operation behavior of sliding the operation hand 2 (for example, a tip of any finger) left and right on the first hole region 12a. The application operation processing apparatus 15 may control the application audiovisual apparatus 13 to play a next sound source program when the operation hand 2 slides to the right on the first hole region 12a and play a previous sound source program when the operation hand 2 slides to the left.

Furthermore, the operator 1 can make an operation behavior of tapping a back surface of the second wheel region 12b once or more (for example, twice) with the operation hand 2 (for example, any finger). In this case, for example, the application operation processing apparatus 15 may control the application audiovisual apparatus 13 so as to move a menu selection of in-vehicle infotainment (IVI) displayed on the application audiovisual apparatus 13 to the right.

Furthermore, the operator 1 can make an operation behavior of tapping a back surface of the third wheel region 12c once or more with the operation hand 2 (for example, any finger). In this case, for example, the application operation processing apparatus 15 may control the application audiovisual apparatus 13 so as to move the menu selection of the IVI displayed on the application audiovisual apparatus 13 to the left.

Note that, in the above example, the steering wheel 12 is used as the input standard region, but other in-vehicle structure may be used as the input standard region.

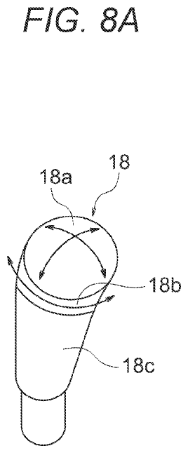

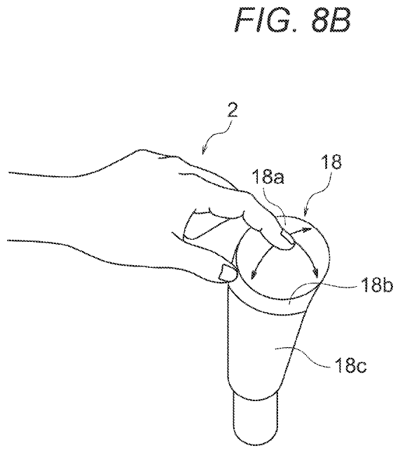

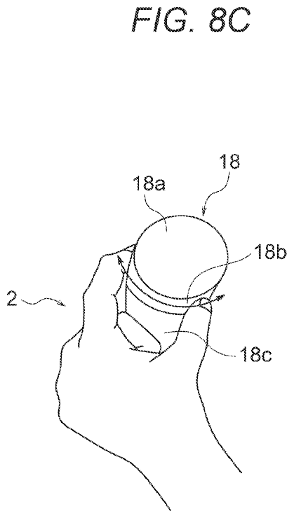

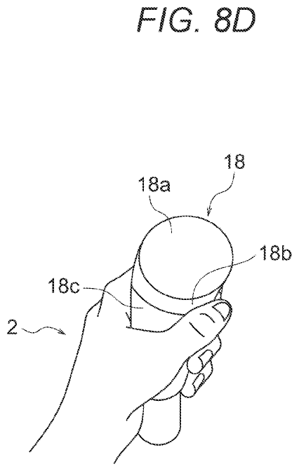

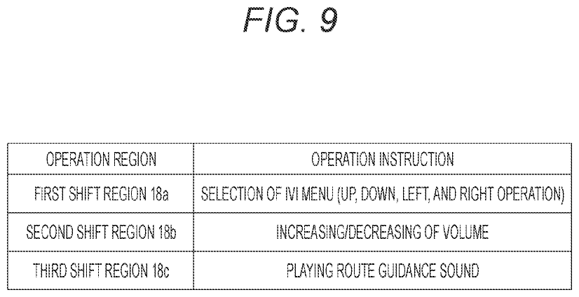

FIG. 8A is a view illustrating an example of a gear shift 18 to be used as the input standard region. FIG. 8B is a view illustrating an example of an operation behavior of the operation hand 2 with respect to a first shift region 18a of the gear shift 18. FIG. 8C is a view illustrating an example of an operation behavior of the operation hand 2 with respect to a second shift region 18b of the gear shift 18. FIG. 8D is a view illustrating an example of an operation behavior of the operation hand 2 with respect to a third shift region 18c of the gear shift 18. FIG. 9 illustrates an example of an operation instruction associated with an operation region (the first shift region 18a to the third shift region 18c) of the gear shift 18.

In the example illustrated in FIGS. 8A to 9, the gear shift 18 (input standard region) includes the first shift region 18a, the second shift region 18b located below the first shift region 18a, and the third shift region 18c located below the second shift region 18b.

The first shift region 18a includes a top surface of the gear shift 18. The second shift region 18b includes an annular side surface of the gear shift 18 that can be pinched by a thumb and an index finger of the operation hand 2. The third shift region 18c includes a lower portion of the gear shift 18 that can be gripped by the operation hand 2.

For example, the operator 1 can make an operation behavior of sliding the operation hand 2 (for example, a tip of any finger) forward, backward, leftward, and rightward on the first shift region 18a. The application operation processing apparatus 15 may control the application audiovisual apparatus 13 to move the menu selection of the IVI up, down, left, and right by sliding the operation hand 2 forward, backward, leftward, and rightward on the first shift region 18a.

Furthermore, the operator 1 can move the operation hand 2 clockwise or counterclockwise while holding the second shift region 18b with the operation hand 2 (a thumb and an index finger in this example). The application operation processing apparatus 15 may control the application audiovisual apparatus 13 to increase sound volume from the application audiovisual apparatus 13 when the operation hand 2 holding the second shift region 18b is moved counterclockwise, and to decrease the sound volume when the operation hand 2 is moved clockwise.

Furthermore, the application operation processing apparatus 15 may control the application audiovisual apparatus 13 to play sound of a route guidance application on the application audiovisual apparatus 13 when the third shift region 18c is gripped by the operation hand 2.

In this manner, the operator 1 can easily operate the application audiovisual apparatus 13 (a navigation system or AV equipment) by moving the operation hand 2 with respect to the input standard region (the steering wheel 12 and the gear shift 18) to indicate a specific operation behavior.

As described above, according to the present embodiment, by using the three-dimensional position measurement apparatus 11, an operation instruction for the vehicle 5 can be flexibly associated with an operation behavior indicated by the occupant (operator 1) of the vehicle 5.

In particular, by using the three-dimensional position measurement apparatus 11 that detects an operation behavior of the operator 1 by using light or other electromagnetic waves, it is possible to suppress an increase in processing and manufacturing load of the existing in-vehicle apparatus.

Furthermore, since the existing in-vehicle apparatus is utilized as the input standard region, it is unnecessary to install a new structure for constituting the input standard region in a vehicle interior having a limited size.

Furthermore, structures (for example, the steering wheel 12 and the gear shift 18) that are likely to be touched by the operator (driver) 1 during driving can be used as the input standard region. In this case, the operator 1 can perform an operation instruction without difficulty with a low-load movement, fatigue of the operator 1 during driving can be reduced, and driving safety of the vehicle 5 is also improved.

Furthermore, it is possible to arrange and design the in-vehicle apparatus relatively freely, and an increase in apparatus cost can also be suppressed.

Furthermore, the operator 1 can input various operation instructions to the vehicle 5 by using the in-vehicle apparatus. Therefore, three-dimensional complicated operation behaviors and various operation behaviors can be associated with various operation instructions, and the operator 1 can perform operation instructions with a high degree of freedom.

### Second Embodiment

In the present embodiment, elements same as or corresponding to those in the first embodiment described above are denoted by the same reference numerals, and the detailed description thereof will be omitted.

In the first embodiment described above, the in-vehicle apparatus (the steering wheel 12 and the gear shift 18) is used as the input standard region, but in the present embodiment, a spatial region is used as the input standard region.

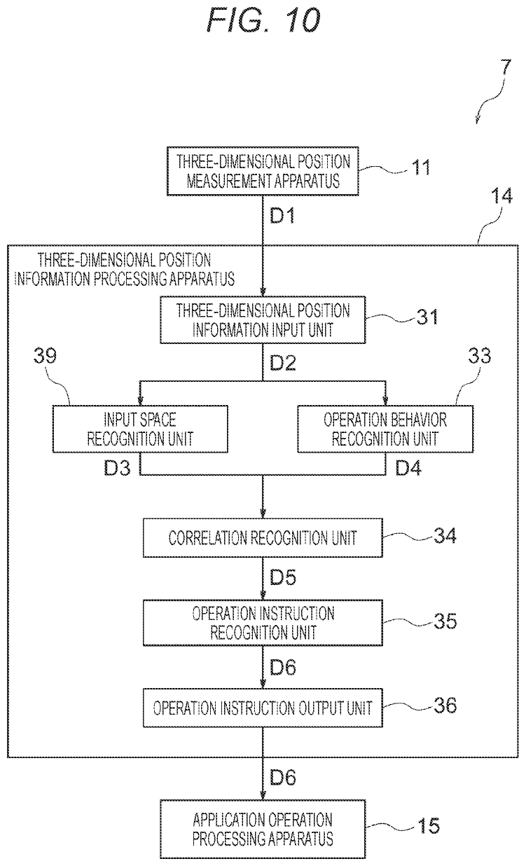

FIG. 10 is a block diagram illustrating a functional configuration example of a three-dimensional position information processing apparatus 14 according to a second embodiment.

In the three-dimensional position information processing apparatus 14 illustrated in FIG. 10, an input space recognition unit 39 is provided as an input standard region recognition unit instead of the in-vehicle apparatus recognition unit 32 (see FIG. 2) described above.

Other functional configurations of the three-dimensional position information processing apparatus 14 illustrated in FIG. 10 are similar to those of the three-dimensional position information processing apparatus 14 illustrated in FIG. 2 described above.

On the basis of three-dimensional position information D2 acquired by a three-dimensional position information input unit 31, the input space recognition unit 39 acquires standard position information D3 indicating a three-dimensional position of a spatial region to be used as the input standard region. The standard position information D3 acquired in this manner is sent from the input space recognition unit 39 to a correlation recognition unit 34, and is used for deriving correlation information D5 together with operation behavior information D4.

The spatial region to be used as the input standard region in the present embodiment may be determined in advance or may be designated by an occupant of a vehicle 5.

In a case where the spatial region to be used as the input standard region is determined in advance, the input space recognition unit 39 may store and hold in advance the standard position information D3 indicating a three-dimensional position of the spatial region, or may read the standard position information D3 from a storage unit (not illustrated) to use the standard position information D3.

In a case where an operator 1 designates the spatial region to be used as the input standard region, the operator 1 can designate a specific spatial region in a vehicle interior as the input standard region by using an operation hand 2. In this case, the input space recognition unit 39 can acquire designated region information representing a region designation behavior indicated by the operator 1, on the basis of a detection result of a sensor of a three-dimensional position measurement apparatus 11, and recognize a designated region designated by the operator 1 on the basis of the designated region information.

The input space recognition unit 39 regards the designated region designated by the operator 1 in this manner as the input standard region, and acquires the standard position information D3 indicating a three-dimensional position of the designated region (input standard region) on the basis of the three-dimensional position information D2.

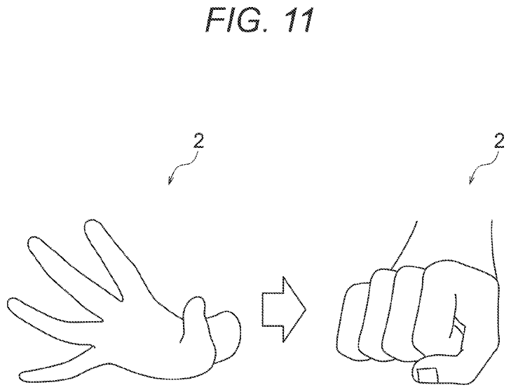

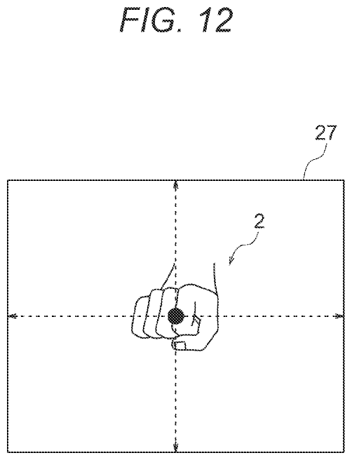

Note that a specific movement mode of the region designation behavior indicated by the operator 1 to designate the input standard region is not limited, and a spatial region corresponding to any designated movement (gesture) indicated by the operator 1 can be determined as the input standard region. FIGS. 11 and 12 illustrate an example of a method of designating a spatial region to be used as the input standard region by the operation hand 2.

In this example, when designating the input standard region, the operator 1 performs a movement of gripping from an opened state of the operation hand 2 at any position in a vehicle interior space (however, a position within a measurement range of the three-dimensional position measurement apparatus 11) as illustrated in FIG. 11.

The input space recognition unit 39 recognizes, as the input standard region, a designated spatial region 27 defined on the basis of a three-dimensional position of the operation hand 2 (first) at the time of performing the hand grip movement. In the example illustrated in FIG. 12, a planar region having a predetermined size in a horizontal direction and a vertical direction (height direction) around the position of the operation hand 2 (first) is recognized by the input space recognition unit 39 as the designated spatial region 27 constituting the input standard region.

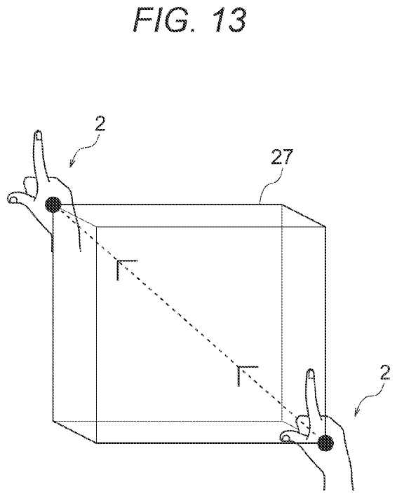

FIG. 13 illustrates another example of the method of designating the spatial region to be used as the input standard region by the operation hand 2.

In the example illustrated in FIG. 13, the operator 1 designates the spatial region to be used as the input standard region by moving the operation hand 2 making an L shape with an index finger and a thumb in the space in the vehicle interior. The input space recognition unit 39 recognizes, as an input standard region, the designated spatial region 27 having a rectangular parallelepiped shape with a movement trajectory of the operation hand 2 as a diagonal line.

As described above, according to the present embodiment, since the spatial region is used as the input standard region, even in a case where an in-vehicle apparatus suitable for the input standard region is not present near the operator 1, the operator 1 can appropriately issue an operation instruction to the vehicle 5. Therefore, an occupant on a passenger seat and an occupant on a rear seat can easily operate the application audiovisual apparatus 13 as the operator 1.

Furthermore, also in a case where there is an in-vehicle apparatus near the operator 1, the operator 1 can give an operation instruction without contacting a specific in-vehicle apparatus, which is convenient. In particular, the occupant on the passenger seat and the occupant on the rear seat can operate the application audiovisual apparatus 13 as the operator 1, without disturbing the driver who drives the vehicle 5.

Furthermore, in a case where the occupant designates the spatial region to be used as the input standard region, the input standard region can be set to any spatial position, so that the position of the input standard region can be changed according to a situation of the operator 1. Therefore, the operator 1 can conveniently give an operation instruction, and the safety of driving of the vehicle 5 is also improved.

### Third Embodiment

In the present embodiment, elements same as or corresponding to those in the first and second embodiments described above are denoted by the same reference numerals, and the detailed description thereof will be omitted.

In general, desirable association between a “relationship between an input standard region and an operation behavior of the operator 1” and an “operation instruction for the vehicle 5” can vary according to a specific daily movement (including habit) or preference of the operator 1.

Therefore, in the present embodiment, association between the “relationship between an input standard region and an operation behavior of the operator 1” and the “operation instruction for the vehicle 5” is determined for each operator 1, and is changed according to the actual operator 1.

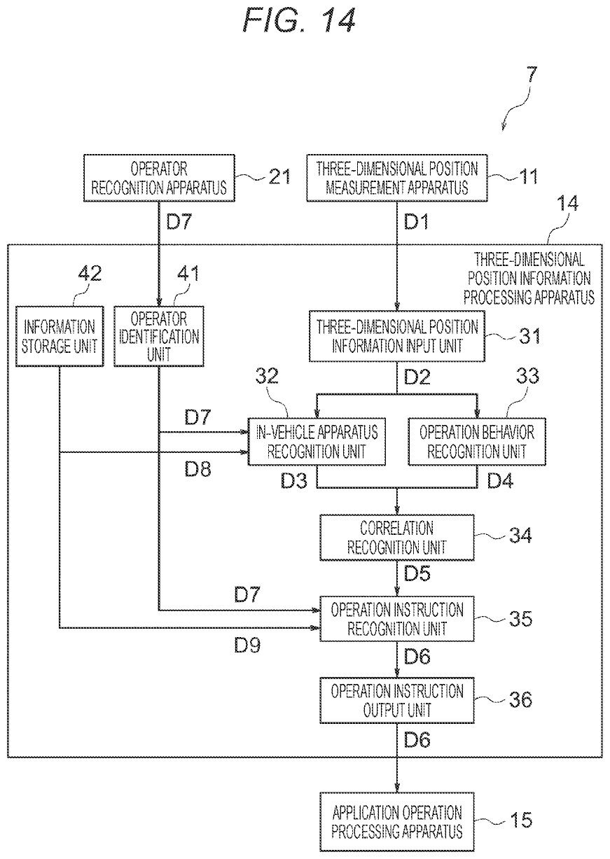

FIG. 14 is a block diagram illustrating a functional configuration example of a three-dimensional position information processing apparatus 14 according to a third embodiment.

The three-dimensional position information processing apparatus 14 illustrated in FIG. 14 includes an operator identification unit 41 and an information storage unit 42.

Other functional configurations of the three-dimensional position information processing apparatus 14 illustrated in FIG. 14 are similar to those of the three-dimensional position information processing apparatus 14 illustrated in FIG. 2 described above.

The operator identification unit 41 acquires identification information D7 indicating the operator 1. The operator identification unit 41 illustrated in FIG. 14 provides the identification information D7 sent from an operator recognition apparatus 21 to an in-vehicle apparatus recognition unit 32 and an operation instruction recognition unit 35.

The operator recognition apparatus 21 is mounted on the vehicle 5, identifies the operator 1 by any method, and acquires the identification information D7. Typically, the operator recognition apparatus 21 includes an imaging apparatus that captures an image of the operator 1, and can acquire the identification information D7 by analyzing imaged data of the operator 1 (for example, face authentication, iris authentication, vein analysis, or fingerprint and palm print analysis). The operator recognition apparatus 21 may acquire the identification information D7 by performing biometric authentication (for example, voice authentication) of the operator 1 by using another biometric authentication apparatus.

In a case of identifying the operator 1 by biometric authentication in this manner, the operator recognition apparatus 21 may perform the identification processing of the operator 1 in response to an active input from the operator 1, or may automatically perform the identification processing of the operator 1 without an active input from the operator 1. Furthermore, the operator recognition apparatus 21 may acquire the identification information D7 on the basis of information input by an occupant of the vehicle 5.

The information storage unit 42 stores and holds reference standard region information D8 and reference operation instruction information D9 in advance, provides the reference standard region information D8 to the in-vehicle apparatus recognition unit 32, and provides the reference operation instruction information D9 to the operation instruction recognition unit 35.

The in-vehicle apparatus recognition unit 32 (input standard region recognition unit) reads the reference standard region information D8 (input standard region information) associated with the identification information D7 from the information storage unit 42. Then, the in-vehicle apparatus recognition unit 32 acquires standard position information D3 representing a three-dimensional position of the input standard region (in-vehicle apparatus) from three-dimensional position information D2 on the basis of the reference standard region information D8.

Note that, in a case where a position of the in-vehicle apparatus constituting the input standard region does not basically change, the reference standard region information D8 may include the standard position information D3 representing a three-dimensional position of the in-vehicle apparatus associated with the identification information D7. In this case, the in-vehicle apparatus recognition unit 32 can acquire the standard position information D3 from the reference standard region information D8.

In this manner, the in-vehicle apparatus recognition unit 32 can acquire the standard position information D3 of the specific input standard region (that is, the specific in-vehicle apparatus) to be linked with the operator 1.

Whereas, the operation instruction recognition unit 35 refers to the reference operation instruction information D9, and acquires operation instruction information D6 associated with the identification information D7 on the basis of correlation information D5 acquired by the correlation recognition unit 34.

The reference operation instruction information D9 is information that makes a relationship between an input standard region and an operation behavior to correspond to operation instruction information, and is determined for each piece of the identification information D7 (that is, for each operator 1).

As described above, the operation instruction recognition unit 35 acquires “Information (the reference operation instruction information D9) making a relationship between an input standard region and an operation behavior to correspond to operation instruction information” determined for the operator 1 on the basis of the identification information D7 provided from the operator identification unit 41. Then, the operation instruction recognition unit 35 acquires, as the operation instruction information D6, the operation instruction information corresponding to “the correlation information D5 indicating a relationship between an input standard region and an operation behavior” in the reference operation instruction information D9.

The operation instruction information D6 thus acquired is sent from the operation instruction recognition unit 35 to the operation instruction output unit 36, and sent from the operation instruction output unit 36 to an application operation processing apparatus 15.

As described above, according to the present embodiment, the input standard region can be changed for each operator 1, or the association between the “relationship between an input standard region and an operation behavior” and the “operation instruction to the vehicle 5” can be changed. Therefore, each operator 1 can give a desired operation instruction with an operation behavior optimized for the individual operator 1.

In particular, in a case where the operator recognition apparatus 21 automatically identifies the operator 1, the three-dimensional position information processing apparatus 14 can automatically perform “change of the input standard region” and “change of the association between the relationship between the input standard region and the operation behavior and the operation instruction” according to the operator 1, which is convenient.

### [Modification]

The technology of the present disclosure is not limited to the above-described embodiments.

For example, in the above-described embodiments, the operation behavior is made by the operation hand 2, but the operation behavior may be made by any other part of the operator 1.

Furthermore, also in a case where the operator 1 operates an information terminal other than the application audiovisual apparatus 13 or a device other than the information terminal, the above-described technology can be applied. Therefore, the operator 1 can also operate any apparatus (for example, an apparatus related to traveling of the vehicle 5) mounted on the vehicle 5 by using the above-described technology.

It should be noted that the embodiments and modifications disclosed in the present description are illustrative only in all respects and are not to be construed as limiting. The above-described embodiments and modifications can be omitted, replaced, and changed in various forms without departing from the scope and spirit of the appended claims. For example, the above-described embodiments and modifications may be combined in whole or in part, and other embodiments may be combined with the above-described embodiments or modifications. Furthermore, the effects of the present disclosure described in the present description are merely exemplification, and other effects may be provided.

A technical category embodying the above technical idea is not limited. For example, the above-described technical idea may be embodied by a computer program for causing a computer to execute one or a plurality of procedures (steps) included in a method of manufacturing or using the above-described apparatus. Furthermore, the above-described technical idea may be embodied by a computer-readable non-transitory recording medium in which such a computer program is recorded.

### [Supplementary Note]

The present disclosure can also have the following configurations.

### [Item 1]

An operation detection apparatus including:
an input standard region recognition unit configured to acquire standard position information representing a three-dimensional position of an input standard region in a conveyance;
an operation behavior recognition unit configured to acquire operation behavior information representing a three-dimensional operation behavior indicated by an operator on board on the conveyance, on the basis of a detection result of a sensor mounted on the conveyance; and
an operation instruction recognition unit configured to acquire operation instruction information representing an operation instruction for the conveyance on the basis of a relationship between the input standard region and the operation behavior, the relationship being derived from the standard position information and the operation behavior information.

### [Item 2]

The operation detection apparatus according to item 1, in which the input standard region is a region defined in advance.

### [Item 3]

The operation detection apparatus according to item 1, in which the input standard region is a designated region designated by the operator.

### [Item 4]

The operation detection apparatus according to item 3, in which the input standard region recognition unit acquires designated region information representing a region designation behavior indicated by the operator on the basis of a detection result of a sensor mounted on the conveyance, and the input standard region recognition unit recognizes the designated region on the basis of the designated region information.

### [Item 5]

The operation detection apparatus according to any one of items 1 to 4, in which the input standard region is a region defined on the basis of a structure mounted on the conveyance.

### [Item 6]

The operation detection apparatus according to any one of items 1 to 4, in which the input standard region is a spatial region.

### [Item 7]

The operation detection apparatus according to any one of items 1 to 6, in which the operation instruction recognition unit acquires the operation instruction information on the basis of a distance between the input standard region and the operator, the distance being derived from the standard position information and the operation behavior information.

### [Item 8]

The operation detection apparatus according to any one of items 1 to 6, in which the operation instruction recognition unit acquires the operation instruction information on the basis of a movement pattern of the operation behavior with respect to the input standard region, the movement pattern being derived from the standard position information and the operation behavior information.

### [Item 9]

The operation detection apparatus according to item 8, in which the operation instruction recognition unit refers to reference instruction information associating the movement pattern of the operation behavior with respect to the input standard region with a corresponding piece of the operation instruction information, to acquire the operation instruction information associated with the movement pattern of the operation behavior with respect to the input standard region, the movement pattern being derived from the standard position information and the operation behavior information.

### [Item 10]

The operation detection apparatus according to any one of items 1 to 9, further including:

an operator identification unit configured to acquire identification information representing the operator, in which the input standard region recognition unit reads input standard region information associated with the identification information from an information storage unit, to acquire the standard position information on the basis of the input standard region information.

### [Item 11]

The operation detection apparatus according to any one of items 1 to 10, further including:

an operator identification unit configured to acquire identification information representing the operator, in which the operation instruction recognition unit refers to reference operation instruction information that is defined for each piece of the identification information and makes a relationship between the input standard region and the operation behavior to correspond to the operation instruction information, and the operation instruction recognition unit acquires the operation instruction information associated with the identification information.

### [Item 12]

The operation detection apparatus according to any one of items 1 to 11, in which the sensor is a ToF sensor.

### [Item 13]

The operation detection apparatus according to any one of items 1 to 12, in which the conveyance is a vehicle.

### [Item 14]

An information processing system including:
a sensor mounted on a conveyance; and
an operation detection apparatus configured to acquire operation instruction information representing an operation instruction for the conveyance, in which the operation detection apparatus includes:
an input standard region recognition unit configured to acquire standard position information representing a three-dimensional position of an input standard region in the conveyance;
an operation behavior recognition unit configured to acquire operation behavior information representing a three-dimensional operation behavior indicated by an operator on board on the conveyance, on the basis of a detection result of the sensor; and
an operation instruction recognition unit configured to acquire the operation instruction information on the basis of a relative relationship between the input standard region and the operation behavior, the relative relationship being derived from the standard position information and the operation behavior information.

### [Item 15]

The information processing system according to item 14, further including a device control unit configured to control a device included in the conveyance on the basis of the operation instruction information.

### [Item 16]

An operation detection method including:
a step of acquiring standard position information representing a three-dimensional position of an input standard region in a conveyance;
a step of acquiring operation behavior information representing a three-dimensional operation behavior indicated by an operator on board on the conveyance, on the basis of a detection result of a sensor mounted on the conveyance; and
a step of acquiring operation instruction information representing an operation instruction for the conveyance on the basis of a relationship between the input standard region and the operation behavior, the relationship being derived from the standard position information and the operation behavior information.

### [Item 17]

The operation detection method according to item 16, further including a step of controlling a device included in the conveyance on the basis of the operation instruction information.

### REFERENCE SIGNS LIST

1 Operator
2 Operation hand
2a Joint point
5 Vehicle
7 Information processing system
11 Three-dimensional position measurement apparatus
12 Steering wheel
12a First hole region
12b Second wheel region
12c Third wheel region
13 Application audiovisual apparatus
14 Three-dimensional position information processing apparatus
15 Application operation processing apparatus
18 Gear shift
18a First shift region
18b Second shift region
18c Third shift region
21 Operator recognition apparatus
25 Modeling element
25a First modeling element
25b Second modeling element
27 Designated spatial region
31 Three-dimensional position information input unit
32 In-vehicle apparatus recognition unit
33 Operation behavior recognition unit
34 Correlation recognition unit
35 Operation instruction recognition unit
36 Operation instruction output unit
39 Input space recognition unit
41 Operator identification unit
42 Information storage unit
D1 measured position information
D2 Three-dimensional position information
D3 Standard position information
D4 Operation behavior information
D5 Correlation information
D6 Operation instruction information
D7 Identification information
D8 Reference standard region information
D9 Reference operation instruction information

1. An operation detection apparatus comprising:
an input standard region recognition unit configured to acquire standard position information representing a three-dimensional position of an input standard region in a conveyance;
an operation behavior recognition unit configured to acquire operation behavior information representing a three-dimensional operation behavior indicated by an operator on board on the conveyance, on a basis of a detection result of a sensor mounted on the conveyance; and
an operation instruction recognition unit configured to acquire operation instruction information representing an operation instruction for the conveyance on a basis of a relationship between the input standard region and the operation behavior, the relationship being derived from the standard position information and the operation behavior information.

2. The operation detection apparatus according to claim 1, wherein the input standard region includes a region defined in advance.

3. The operation detection apparatus according to claim 1, wherein the input standard region includes a designated region designated by the operator.

4. The operation detection apparatus according to claim 3, wherein the input standard region recognition unit acquires designated region information representing a region designation behavior indicated by the operator on a basis of a detection result of a sensor mounted on the conveyance, and the input standard region recognition unit recognizes the designated region on a basis of the designated region information.

5. The operation detection apparatus according to claim 1, wherein the input standard region includes a region defined on a basis of a structure mounted on the conveyance.

6. The operation detection apparatus according to claim 1, wherein the input standard region includes a spatial region.

7. The operation detection apparatus according to claim 1, wherein the operation instruction recognition unit acquires the operation instruction information on a basis of a distance between the input standard region and the operator, the distance being derived from the standard position information and the operation behavior information.

8. The operation detection apparatus according to claim 1, wherein the operation instruction recognition unit acquires the operation instruction information on a basis of a movement pattern of the operation behavior with respect to the input standard region, the movement pattern being derived from the standard position information and the operation behavior information.

9. The operation detection apparatus according to claim 8, wherein the operation instruction recognition unit refers to reference instruction information associating the movement pattern of the operation behavior with respect to the input standard region with a corresponding piece of the operation instruction information, to acquire the operation instruction information associated with the movement pattern of the operation behavior with respect to the input standard region, the movement pattern being derived from the standard position information and the operation behavior information.

10. The operation detection apparatus according to claim 1, further comprising:
an operator identification unit configured to acquire identification information representing the operator, wherein
the input standard region recognition unit reads input standard region information associated with the identification information from an information storage unit, to acquire the standard position information on a basis of the input standard region information.

11. The operation detection apparatus according to claim 1, further comprising:
an operator identification unit configured to acquire identification information representing the operator, wherein
the operation instruction recognition unit refers to reference operation instruction information that is determined for each piece of the identification information and makes a relationship between the input standard region and the operation behavior to correspond to the operation instruction information, and the operation instruction recognition unit acquires the operation instruction information associated with the identification information.

12. The operation detection apparatus according to claim 1, wherein the sensor includes a ToF sensor.

13. The operation detection apparatus according to claim 1, wherein the conveyance includes a vehicle.

14. An information processing system comprising:
a sensor mounted on a conveyance; and
an operation detection apparatus configured to acquire operation instruction information representing an operation instruction for the conveyance, wherein the operation detection apparatus includes:
an input standard region recognition unit configured to acquire standard position information representing a three-dimensional position of an input standard region in the conveyance;
an operation behavior recognition unit configured to acquire operation behavior information representing a three-dimensional operation behavior indicated by an operator on board on the conveyance, on a basis of a detection result of the sensor; and
an operation instruction recognition unit configured to acquire the operation instruction information on a basis of a relationship between the input standard region and the operation behavior, the relationship being derived from the standard position information and the operation behavior information.

15. The information processing system according to claim 14, further comprising a device control unit configured to control a device included in the conveyance on a basis of the operation instruction information.

16. An operation detection method comprising:
a step of acquiring standard position information representing a three-dimensional position of an input standard region in a conveyance;
a step of acquiring operation behavior information representing a three-dimensional operation behavior indicated by an operator on board on the conveyance, on a basis of a detection result of a sensor mounted on the conveyance; and
a step of acquiring operation instruction information representing an operation instruction for the conveyance on a basis of a relationship between the input standard region and the operation behavior, the relationship being derived from the standard position information and the operation behavior information.

17. The operation detection method according to claim 16, further comprising a step of controlling a device included in the conveyance on a basis of the operation instruction information.
